(19) United States
(12) Patent Application Publication
(10) Pub. No.: US 2018/0152393 A1
(43) Pub. Date: May 31, 2018

(54) APPLICATION RESOURCE USAGE REDUCTION

(71) Applicant: Microsoft Technology Licensing, LLC, Redmond, WA (US)

(72) Inventors: Kristofer D. Hoffman, Sammamish, WA (US); Chia-Jiun Tan, Bellevue, WA (US)

(21) Appl. No.: 15/362,788

(22) Filed: Nov. 28, 2016

(51) Int. Cl. H04L 12/927; H04L 12/863; H04L 29/08

(52) U.S. Cl. CPC H04L 47/803; H04L 67/10; H04L 67/06; H04L 47/6255

(57) ABSTRACT

Application resource usage reduction can be accomplished by reducing an application's attempts at uploading content (and calls to a network interface) when there is a fail state at the device. The application can carry out this reduction by managing an upload queue, including pausing and un-pausing the upload queue based on failure states identified to the system before or after an attempt is made to upload content. For example, outside of the upload process, the application can detect network connection changes such that at any time the application detects a loss of the network connection, the upload queue is set to a paused state where no upload attempt would be performed, even if new content is indicated at the upload queue.

### BACKGROUND

Cloud storage is a model of data storage in which data is stored on remote servers accessed from the Internet, or “cloud”. Cloud storage services are Internet hosting services that allow a user to upload and sync their files to a cloud storage and access those files from any device, such as a mobile phone, tablet, or computer, that is connected to the Internet.

There are many cloud storage services, such as MICROSOFT ONEDRIVE, DROPBOX, GOOGLE DRIVE, BOX, and APPLE ICLOUD DRIVE. Some operating systems have backup functionality that interact with the cloud storage services. More specifically, some operating systems have built in communications to the cloud storage service.

Currently, applications that are outside of the operating system can waste resources by continuing to attempt to upload a file, as well as trying to upload different files multiple times, even when there is no network connection.

### BRIEF SUMMARY

Techniques for reducing resource usage for applications that upload content to the cloud are described.

An application can manage an upload queue for transmitting content received at a computing device to a cloud service. The content may include, but is not limited to, photos, screenshots, saved files, and the like. Managing the upload queue may include adding detected new content to the upload queue and indicating the new content as new in the upload queue. Managing the upload queue may further include indicating the new content as sent in the upload queue, if the new content successfully transmits to the cloud service; and indicating content that has failed to upload as new in the upload queue. Additionally, managing the upload queue may further include pausing and un-pausing the upload queue based on a detected state change.

The application can communicate with an operating system of the computing device to transmit any content indicated as new in the upload queue while the upload queue is indicated to be in an un-paused state to the cloud service using a network resource of the computing device. Advantageously, the application, outside of the new content process, detect network connection changes of a loss of network connection and an availability of the network connection, such that in response to detecting the loss of the network connection, the application sets the upload queue to a paused state where no upload attempt would be performed, even if a new content is indicated. Other fail states may be detected and used to pause or unpause the queue.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment in which various embodiments of the invention may be practiced.

FIG. 2 illustrates an example implementation of an application incorporating application resource usage reduction such as described herein.

FIG. 3 illustrates an example process flow diagram of a method for providing an automatic upload of content without resource usage reduction.

FIGS. 4A and 4B illustrate example process flow diagrams of methods for providing resource use reduction.

FIG. 5 illustrates an example process flow diagram of a method for providing resource use reduction.

FIG. 6 illustrates an example user interface of an application that incorporates application resource usage reduction.

FIG. 7 shows a block diagram illustrating components of a computing device that may be used in certain implementations described herein.

### DETAILED DESCRIPTION

Techniques for reducing resource usage for applications that upload content to the cloud are described.

An application can manage an upload queue for transmitting content received at a computing device to a cloud service. The terms “application” and “app” are used interchangeably herein. In addition, the terms “transmit” and “upload” may be used interchangeably herein. The content may include, but is not limited to, photos, screenshots, saved files, and the like. Managing the upload queue may include adding detected new content to the upload queue and indicating the new content as new in the upload queue. Managing the upload queue may further include indicating the new content as sent in the upload queue, if the new content successfully transmits to the cloud service; and indicating content that has failed to upload as new in the upload queue. Additionally, managing the upload queue may further include pausing and un-pausing the upload queue based on a detected state change.

The application can communicate with an operating system of the computing device to transmit content indicated as new in the upload queue to the cloud service using a network resource of the computing device. Advantageously, outside of the upload process, the app can further detect network connection changes of a loss of network connection and an availability of the network connection, such that in response to detecting the loss of the network connection, the app can set the upload queue to a paused state where no upload attempt would be performed, even if a new content is indicated.

Advantageously, the described techniques incorporate identifying current network availability status, which leads the software program to reduce resources that would have been wasted by trying to upload multiple times when there is no network connection. Furthermore, the detection of network availability is performed outside of the upload process so that the upload process does not require checking for network connectivity before uploading each time new content is detected.

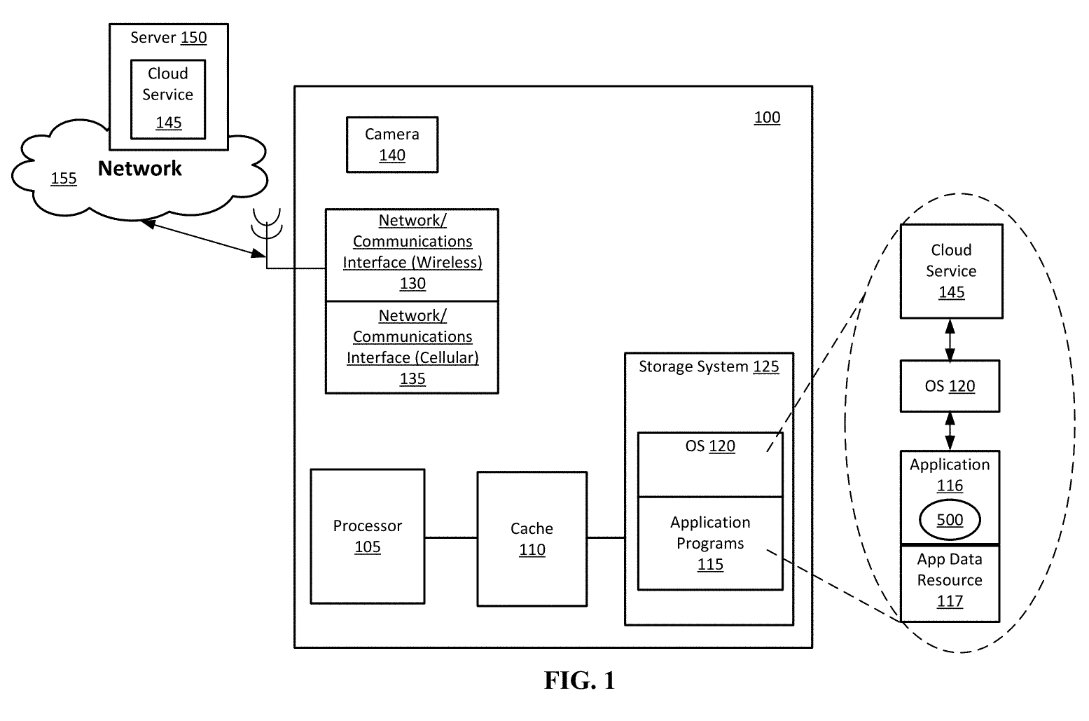

FIG. 1 shows an example operating environment in which embodiments of the invention may be practiced. Referring to FIG. 1, an example operating environment can include a computing device 100 operably coupled to a network 155 to communicate with a cloud service 145, as well as other user computing devices (not shown). The cloud service 145 can be implemented by one or more servers, such as server 150.

The network 155 can be, but is not limited to, a cellular network (e.g., wireless phone), a point-to-point dial up connection, a satellite network, the Internet, a local area network (LAN), a wide area network (WAN), a WiFi network, an ad hoc network or a combination thereof. Such networks are widely used to connect various types of network elements, such as hubs, bridges, routers, switches, servers, and gateways. The network 155 may include one or more connected networks (e.g., a multi-network environment) including public networks, such as the Internet, and/or private networks such as a secure enterprise private network. Access to the network 155 may be provided via one or more wired or wireless access networks as will be understood by those skilled in the art.

The computing device 100 can be, but is not limited to, a personal computer (e.g. desktop computer), laptop, personal digital assistant (PDA), mobile phone (or smart phone), tablet, slate, a gaming device or console, a smart television, or terminal, which may be used to access a server, such as server 150, over the network 155. The server 150 may be an enterprise server, cloud based server, dedicated server, host server, or the like.

It should be apparent that the computing device 100 may be any type of computer system that provides its user the ability to load and execute software programs and the ability to access a network, such as network 155, and communicate with one or more servers, such as server 150, as well as other computing devices (not shown).

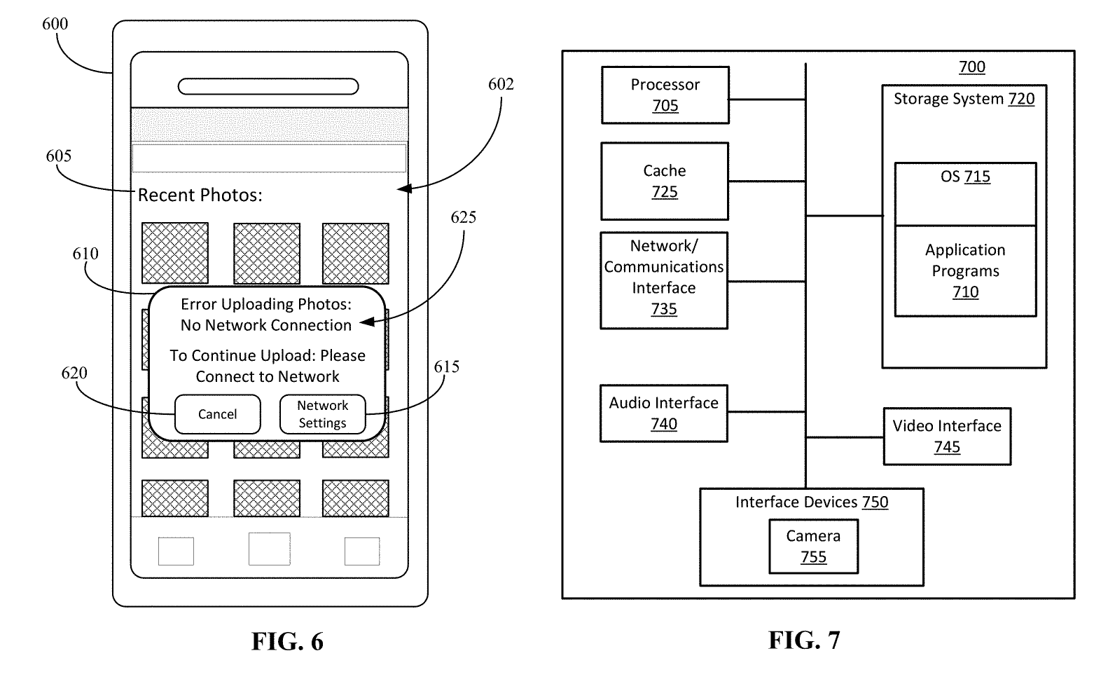

The computing device 100 may be embodied such as described with to computing system 700, as shown in FIG. 7. For example, the computing device 100 is configured to receive input from a user, such as by voice, touch, and/or through a keyboard and/or mouse that is operably coupled to the computing device 100. The computing device 100 can further include a display (e.g., a computer monitor), that is configured to display one or more user interfaces to the user. In some examples, the display can be a touchscreen such that the computing device 100 may receive user input through the display.

Additionally, the computing device 100 can be configured with one or more central processing units (CPUs), such as a processor 105, memory, such as a cache 110, mass storage, such as storage system 125, and I/O devices, such as network interface (e.g., a wireless network/communications interface 130 and a cellular network/communication interface 135) and user input device (e.g., such as a camera 140). Elements of the computing device 100 can communicate with each other via a bus.

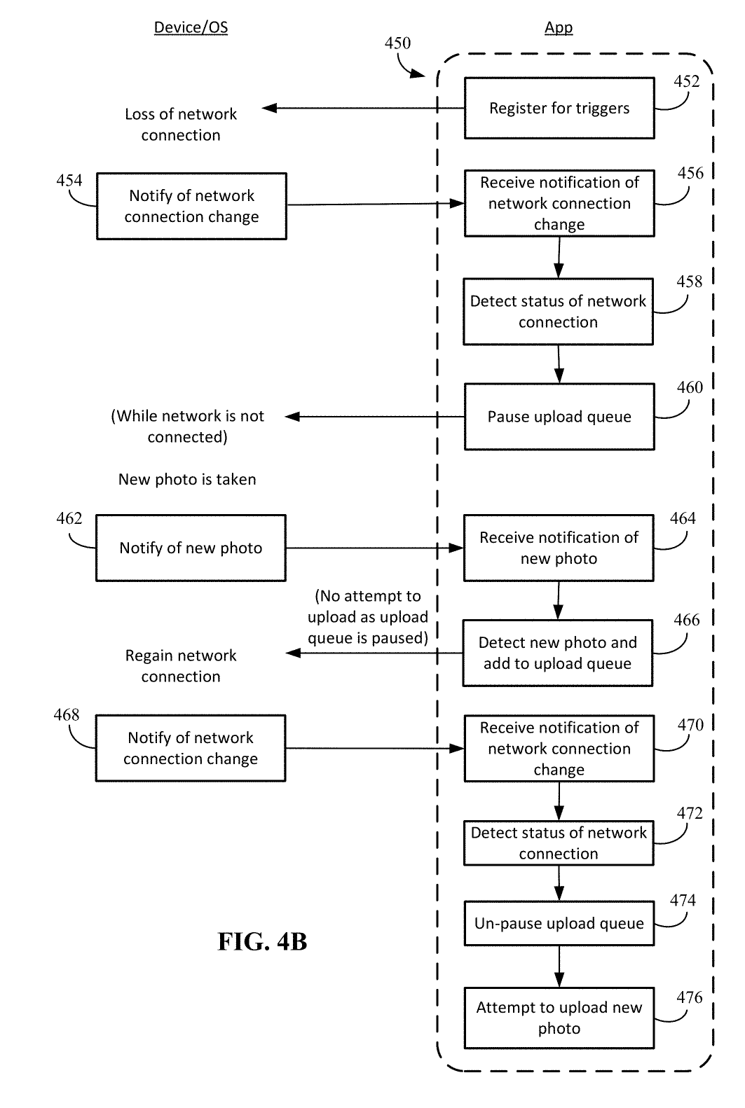

The computing device 100 is configured to execute an operating system 120 and one or more application programs 115. The application programs 115 could be apps downloaded from an app store which have limited access to the underlying computing device 100. One such program may be app 116, with functionality of processes 500, as described in FIG. 5.

The operating system 120 is a computer program for controlling the operation of the computing device 100. The application programs 115 are executable programs configured to execute on top of the operating system 120 to provide various functionality and can include an application that communicates with a cloud storage, such as app 116. The app 116, with functionality of processes 500, as described in FIG. 5, is given rights by the operating system 120 to access a resource of the computing device 100. Therefore, since the app 116 has limited access to the underlying computing device 100, the app 116 communicates with the operating system 120 in order to access components of the computing device 100. An exploded view is provided in FIG. 1 to show this communication.

As previously mentioned, the app 116 communicates with the cloud service 145 as part of its features, for example to exchange content. The app 116 goes through the operating system 120 in order to communicate with the cloud service 145 over the network; and the operating system 120 allows the app 116 the access to the network interface, such as network/communication interface 130 or the cellular network/communication interface 135.

The app 116 manages the upload queue for transmitting content to a cloud service 145. The upload queue can be a data structure stored at an app data resource 117. The app data resource can be a section of the storage system 125 that the computing device 100 assigns (via operating system 120) to the app 116, allowing the app 116 to control what happens in that storage section. The upload queue data structure may be a database table that identifies content to be uploaded to the cloud service 145. The database table can include information that indicates whether content is new, sent, or failed. For example, an indication of new may signify that the content is ready to be uploaded to the cloud service 145; an indication of sent may signify the content was successfully uploaded to the cloud service 145; and an indication of failed may signify there was an unsuccessful attempt to upload the content to the cloud service 145.

Other useful information, such as information that helps the app 116 manage the upload queue, may be stored in the app data resource 117. For example, the app data resource 117 may contain error information and pause state information of the upload queue.

The app 116 communicates with the operating system 120 via one or more application programming interfaces (APIs). Further description of APIs are provided with respect to FIG. 7.

Through the APIs, the operating system 120 may provide triggering functionality. The app 116 can register with the operating system 120, allowing for the app 116 to receive notifications associated with the registered triggers. For example, the app 116 could register for a network change trigger. Then, if the state of the network connection changes, for example, from a usable network connection to no usable network connection, the app 116 receives a notification from the operating system 120 of the change and the app 116 can take appropriate action. Further, the app 116 could register for a content change trigger. The content change trigger may be for a specified folder in particular or for multiple folders (or anywhere on the computing device 100) in general. With the content change trigger, if the content changes in the specified folder(s) (in particular or in general), the app 116 receives a notification of the change from the operating system 120 and the app 116 can take appropriate action. For example, given a registration for a content change trigger for a camera roll, if a photo is taken with a camera of the computing device 100 and stored on a camera roll, the app 116 receives a notification of the change in the camera roll from the operating system 120 and the app 116 can take appropriate action.

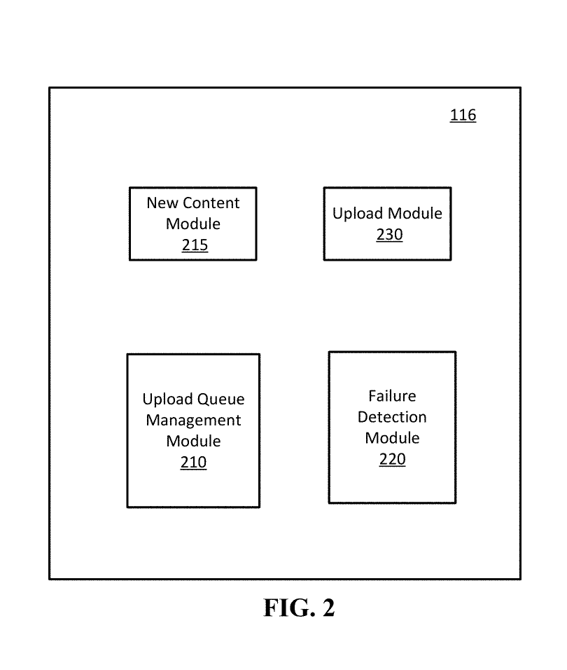

FIG. 2 illustrates an example implementation of an application incorporating application resource usage reduction such as described herein. Referring to FIG. 2, the app 116 contains an upload queue management module 210, a new content module 215, a failure detection module 220, and an upload module 230. Additionally, the app 116 may include other modules associated with various functionality of the app 116.

The upload queue management module 210 includes the functionality associated with the management of the upload queue for transmitting content received at a computing device to a cloud service. The content may include, but is not limited to, saved files, photos, screenshots, and the like, that have been saved to the computing device. For example, the upload queue management module 210 receives the identity of new content from the new content module 215 and includes the new content as an entry in the upload queue data structure. Additionally, the upload queue management module 210 can indicate the new content as new in the upload queue, allowing the upload module 230 to know the new content is ready to be transmitted to the cloud service. After receiving communication of an unsuccessful upload from the upload module 230, the upload queue management module 210 can indicate failed content as new in the upload queue, allowing the upload module 230 to know the failed content is ready to be transmitted to the cloud service again. Also, after receiving communication of a successful upload from the upload module 230, the upload queue management module 210 can indicate the new content as sent in the upload queue.

Further, the upload queue management module 210 can place the upload queue in a paused state or an un-paused state by, for example, storing a flag or using a pause bit to indicate the upload queue is in a paused state. If the upload queue is placed in a paused state, no upload attempt is performed by the upload module 230, even if new content is indicated by the upload queue management module 210. More specifically, if upload queue is in the paused state, the upload module 230 may not communicate with the operating system to transmit the new content to the cloud service. Further, if the upload queue is set to an un-paused state, the upload module 230 may communicate with the operating system to transmit the new content indicated by the upload queue management module 210 to the cloud service. Advantageously, the upload module 230 can rely on the paused or unpaused state of the upload queue to determine action.

The upload module 230 includes the functionality associated with transmitting content to the cloud storage service. For example, when the upload queue includes content indicated as new by the upload queue management module 210 and is in an un-paused state, the upload module 230 communicates with the operating system of the computing device to transmit the new content to the cloud service using a network resource of the computing device. For example, the operating system can allow the upload module 230 access to a network interface, such as a wireless network/communication interface or a cellular network/communication interface.

Additionally, the app 116 may register with the operating system for triggers, allowing the app 116 to receive notifications when new content is stored on the device or if there is a network connection change or other state change. The new content module 215 includes the functionality associated with detecting new content. The new content module 215 may detect new content in a variety of ways. For example, when the app 116 receives a notification indicating a content change, the new content module 215 may access, via the operating system, the storage system and identify the new content, allowing the upload queue management module 210 to include the new content as an entry in the upload queue data structure.

Further, the new content module 215 may also detect new content by identifying that the device has received input, such as the camera being used, without receiving notification from the operating system. The new content module 215 may then look for the new content in the media storage.

The failure detection module 220 includes the functionality associated with detecting changes in the system, such as a network connection change or a state change. For example, the failure detection module 220 may detect network connection changes of a loss of network connection and an availability of the network connection, such that in response to detecting the loss of the network connection the failure detection module 220 communicates with the upload queue management module 210, allowing the upload queue management module 210 to set the upload queue to a paused state where no upload attempt would be performed even if a new content is indicated. Further, the upload queue management module 210 can set the upload queue to an un-paused state in response to the failure detection module 220 detecting and communicating the availability of the network connection. Advantageously, the failure detection module 220 can operate outside of the upload process.

In another example, if the app 116 receives a failure indication of a failure to transmit the content indicated as new in the upload queue to the cloud service, the app 116 may store the indication of the failure. The indication of the failure may indicate a known error, such as a network connection error. The failure detection module 220 may detect the known error received in the stored failure indication and then communicate with the operating system to confirm the known error. If the known error is confirmed by the operating system, the failure detection module 220 can communicate to the upload queue management module 210 to pause the upload queue by placing the upload queue in a paused state, as well as indicate the failed content as new in the upload queue. The failure detection module 220 may also, via the operating system, inform the user of the error through a user interface. This can allow the user to fix the error and the upload of content can be resumed by setting the upload queue to an un-paused state.

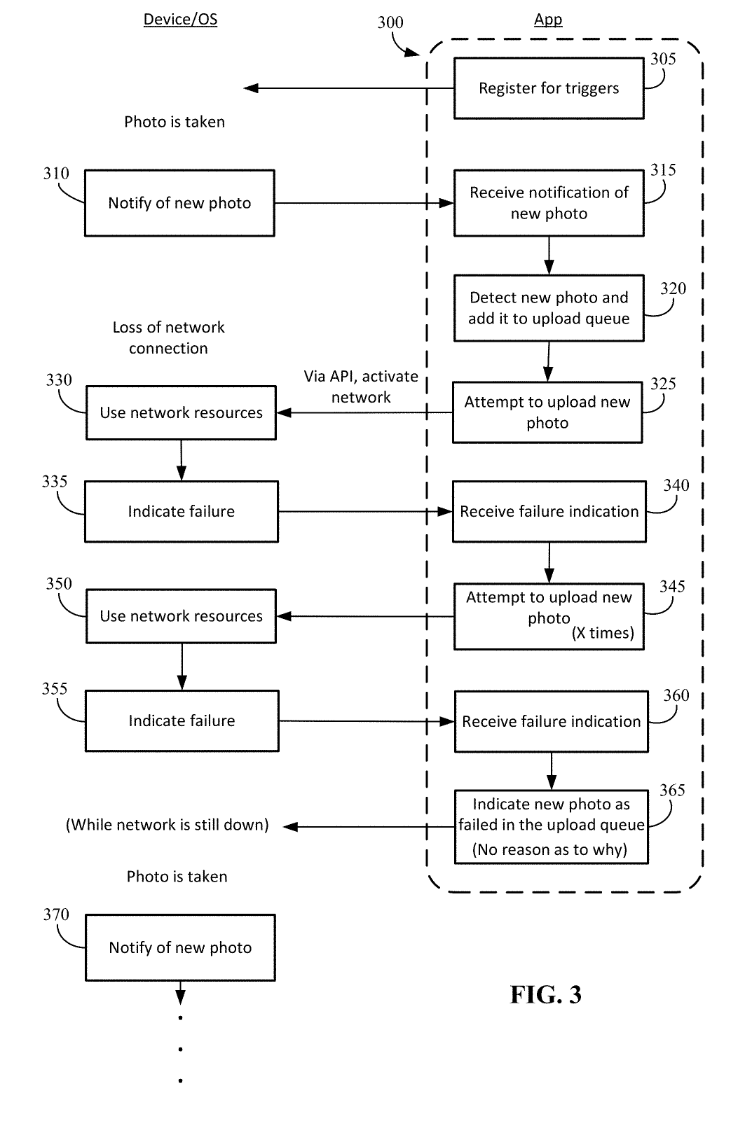

FIG. 3 illustrates an example process flow diagram of a current method for providing an automatic upload of content without resource usage reduction. As previously described, the applications may have limited access to the underlying system and, therefore, have strict resource limitations. Referring to FIG. 3, process 300 is an example of a problem that can arise due to these constraints.

In a specific example, a cloud storage app may have a feature that uploads content to the user's cloud storage. This feature can automatically detect new content, such as photos, screenshots, and saved files, and upload them to the user's cloud storage account. However, if the user does not have a network connection that the app can use to upload those files, then the feature can start to break down. Any files that are detected are added to the upload queue and the app tries to upload those files. However, because the computing device does not have a working network connection, that file upload fails. Thus, the app may be using battery power, memory, CPU system, and other system resources trying to upload a file that is assured to fail. Further, once the file fails, it may be possible that the failure will not be cleared and that file will not automatically upload when the device is reconnected to the network connection.

In more detail, an app can register for one or more triggers (305) with the operating system of the user's computing device, allowing the app to receive notifications associated with the registered triggers. Then, when a photo is taken and stored on the device, the operating system will notify the app that there is a new photo (310). When the app receives the notification of the new photo from the operating system (315), the app can detect the new photo and add the new photo to an upload queue (320) by indicating the new photo as new in the upload queue.

As illustrated in FIG. 3, the device may have lost a network connection. However, since the new photo is indicated as new and thus ready to upload, the app will attempt to upload the new photo by activating the network, via an API with the operating system (325). The attempted upload uses network resources of the device (330) and because of the loss of network connection, the attempt to upload the new photo fails. The operating system indicates a failure of the upload (335) and the app receives a failure indication (340). Since the app may receive the failure indication without knowing why the upload attempt failed, the app does not know that the upload should not be attempted again. Therefore, the app attempts to upload the new photo (345) multiple times. The number of times the app attempts the upload may be based on policy rules. With each attempted upload, the app may use network resources of the device (350); and each time, the attempt to upload may fail if the network connection is still down. Further, each time, the operating system sends an indication of failure to the app without indicating a known error (355). The app receives the failure indication (360), and after attempting the upload the specified number of times according to the policy rules, the app indicates the new photo as failed in the upload queue (365) without providing the reason as to why the upload attempt failed.

Additionally, in this scenario, while the network is still down, another photo may be taken and the operating system notifies the app of the new photo (370). This process may continue multiple times and each time the attempted upload fails, while using network resources, because there was no indication of an error.

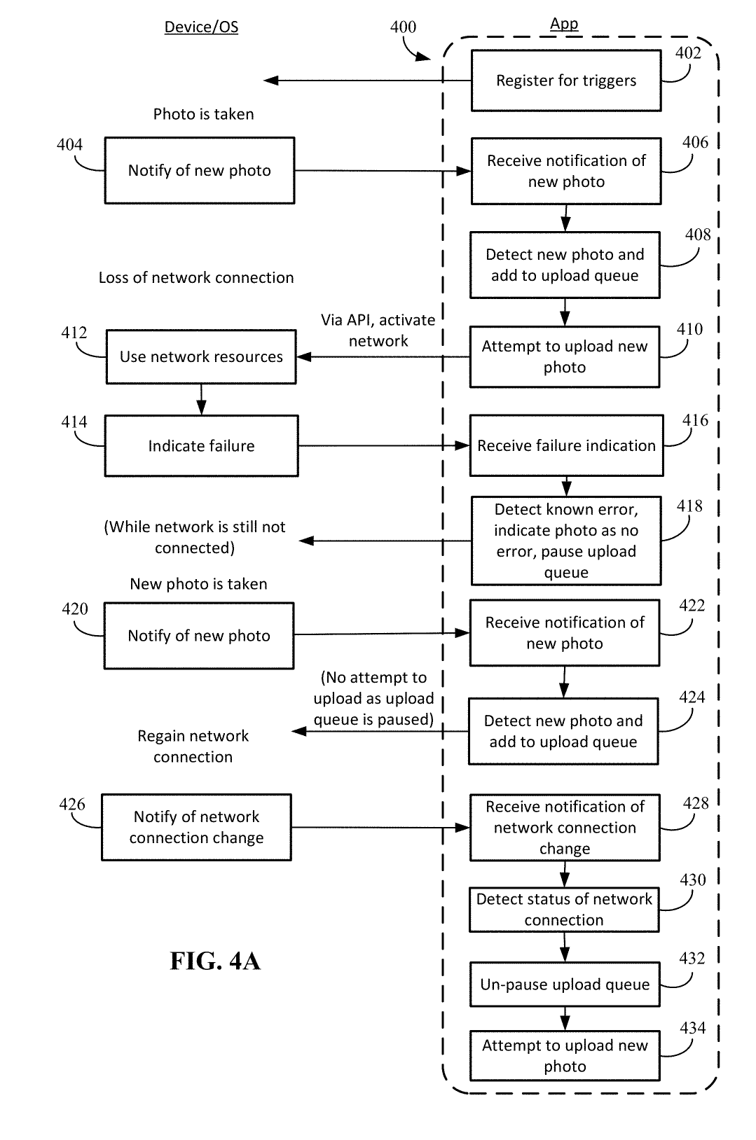

FIGS. 4A and 4B illustrate example process flow diagrams of a method for providing resource use reduction; and FIG. 5 illustrates an example process flow diagram of a method for providing resource use reduction.

According to various examples, the app can detect if there is no network connection, or if there is a fail state, and still detect any new content as soon as the new content comes in. The app can add the new content to the upload queue. However, the app may not actually upload that new content because the app knows the upload will fail and this knowledge is used to pause and unpause the upload queue. When the device gains a usable network connection or returns to a successful state, the app can detect the connection and then un-pause the upload queue so the new content may start to upload to the cloud service again. Advantageously, the app can detect and take into account the network connection status, or fail state status, independently, and then stop the upload queue from uploading while the network connection is down or the system contains a fail state, thus reducing resource usage.

FIGS. 4A and 4B provide a more detailed description illustrating how the resource usage reduction can be carried out. FIG. 4A describes a scenario where network connectivity error is identified after new content is identified for the upload queue; and FIG. 4B describes a scenario where the network connectivity error is identified before new content is identified for the upload queue.

As illustrated by the scenarios of FIGS. 4A and 4B, it is possible to avoid the situation described by process 300 in FIG. 3 where the app may retry the attempt to upload the content multiple times.

Referring to FIG. 4A, an application can register for one or more triggers with an operating system (402) to be notified when new content is added or a network connection state has changed; or more specifically, when a device implementing the app has lost or gained connectivity. For example, a MICROSOFT ONEDRIVE app for a WINDOWS operating system uses two triggers to determine if there is no network connection or new content. These triggers may include a network change trigger and a content change trigger available from the operating system. For example, the network change trigger may be a SystemTrigger using the NetworkStateChange type and an individual file upload failure that reports that the failure was caused by WebErrorStatus.OperationCanceled. The triggers may be set to run all the time instead of only when there is a network connection. Therefore, the app can detect content and add the content to the upload queue even when there is no network connection. If a file upload fails and the app receives an error of WebErrorStatus.OperationCanceled, the app checks the current connection state and pauses the upload queue if there is no network connection. Further, when the app is notified that the network state has changed (e.g. gained a Wi-Fi connection or lost a data connection), via the NetworkStateChange trigger, the app will then check to see if there is a usable network connection.

After the app registers for the one or more triggers (402) and when a photo is taken and stored on the device, for example in the camera roll, the operating system can notify the app of the new photo (404). The app can receive notification of the new photo (406) and proceed to detect the new photo and add the new photo to the upload queue (408). For example, the app may indicate the new photo as new in the upload queue and therefore ready to be transmitted to a cloud service.

Once the new photo is indicated as new in the upload queue, the app, via an API with the operating system, may activate the network and attempt to upload the new photo (410), which can use network resources of the device (412). However, if the device loses the network connection, as illustrated in this scenario, prior to attempting to upload the new photo (410), the attempt to upload will fail. If the upload fails, the operating system communicates an indication of a failure (414) to the app, which can report of the failure to upload the new content, as well as the reason for the failure (e.g., what type of error caused the failure). For example, since the app is registered for the network change trigger, the operating system can report that the failure was caused by a known network error, such as WebErrorStatus.OperationCanceled.

In some examples, if the app receives the failure indication (416), the app may store the indication of the network failure. The app can then detect the known network error, indicate the photo as no error, and pause the upload queue (418). For example, when the app receives the failure indication from the operating system, the failure indication may include the type of error, such as a network connection error. The app can check the type of error received, and if the error is a network connection error, the app can check the current state of the network by communicating with the operating system and pause the upload queue if there is no usable network connection. Advantageously, the app can also put the content (e.g., current content upload) that failed back into the upload queue, by indicating the failed content as new. Therefore, when the device regains the network connection, previously failed content will be indicated as new and automatically uploaded.

In various examples, instead of pausing the upload queue after determining there is no usable network connection, the app can send an error message to the user indicating there is a network error and in order to fix the error, the user should connect to a network. Then, if the user connects to a network, the app can attempt to upload the content again, by un-pausing the upload queue.

Pausing the upload includes setting the upload queue to a paused state, where no upload attempt would be performed even if new content is indicated. Un-pausing the upload includes setting the upload queue to an un-paused state, where an upload attempt is performed if new content is indicated. The app may set the upload queue to a paused state in a variety of ways. For example, the app may store a pause bit, or a flag, that indicates whether the upload queue is paused or un-paused.

As illustrated in this scenario, while the network is still not connected, a new photo is taken and stored by the device. The operating system then notifies the app of the new photo (420) and the app receives that notification of the new photo (422). The app can then detect the new photo and add the new photo to the upload queue (424). In this case, since the upload queue is paused, no attempt is made by the app to upload the new content.

When the device regains the network connection, the operating system can notify the app of the network connection change (426). As previously described, when the app receives notification of a network connection change (428), for example, via the network change trigger, the app checks to see if there is a usable network connection by detecting the status of the network connection (430), which may include communicating with the operating system to confirm a useable network connection. Since the network connection was regained, the app detects a usable network connection and un-pauses the upload queue (432). The app, via an API with the operating system, may activate the network and attempt to upload the new photo in the upload queue (434) again.

Referring to FIG. 4B, an application can register for one or more triggers with an operating system (452) to be notified there is new content, or a network connection state has changed, more specifically, when the computing device has lost or gained connectivity. If, after the application registers for the one or more triggers (452), as illustrated in this scenario, the device loses network connection, the operating system notifies the app of the network connection change (454).

The app can receive the notification of the network connection change from the operating system (456) and then proceeds to detect the status of the network connection (458) by communicating with the operating system to confirm there is no useable network connection. In some examples, as previously described, after determining there is no usable network connection, the app can send an error message to the user indicating there is a network error and how to fix the error. Then, if the user fixes the error and connects to a network, the app resumes uploading the content by setting the upload queue to an un-paused state.

Once the app detects that there is no network connection, the app can then pause the upload queue (460), using any of the previously described methods. When the upload queue is in a paused state, no upload attempts are performed, even if new content is indicated in the upload queue.

If, while there is no network connection, as illustrated in this scenario, a photo is taken and stored in the system, the operating system will notify the app of the new photo (462). When the app receives the notification of a new photo (464), the app can then detect the new photo and add the new photo to the upload queue (466). However, since the upload queue is in the paused state, the new photo can be added to the upload queue, but there will be no attempt to upload the new photo.

When the device regains the network connection, as illustrated in this scenario, the operating system notifies the app of the network connection change (468) and the app receives the notification of the network change (470). As soon as the app receives the notification of the network change (470), the app detects the status of the network connection (472), by communicating with the operating system to confirm there is a usable network connection, and un-pause the upload queue (474). Once the upload queue is in an un-paused state, the app attempts to upload the new photo (476) that was previously added to the upload queue.

Referring to FIG. 5, the resource usage reduction may be used for a variety of fail state situations, in addition to a loss of network connection. During process 500, an app may detect the existence of a fail state. The app may detect the fail state in a variety of ways. For example, the app may register for triggers, such as a content change trigger and a network change trigger, as previously described. As another example, the app may have a thread running and proceed to detect the existence of a fail state without being first notified by the operating system.

If the device goes into a fail state that the application has registered to receive some kind of trigger from the operating system, the operating system can notify the app of a state change (505). In some cases, the fail state is a condition identified by the application and is not a device error. For example, a fail state may occur due to the server (that the application communicates with to upload content) being over quota for a particular user. For example, if a cloud storage limits the amount of storage for each user, such as 5 GB of storage, the user may have filled their allotted storage space in the cloud storage, causing a fail state. Another example of when a fail state may occur is if a user's password to the cloud storage has expired.

The app can receive the notification of the state change from the operating system (510) and then detect the status of the state change (515) by communicating with the operating system to confirm the fail state. Once the app detects that there is a fail state, the app can then pause the upload queue (520), by any of the previously described methods. When the upload queue is in a paused state, no upload attempts are performed, even if new content is indicated in the upload queue.

In various examples, after receiving notification of a state change from the operating system, confirming the fail state, and setting the upload queue to a paused state, the app may communicate an error message with the user through a user interface. The error message may indicate the type of fail state and how to fix the fail state. If the user chooses to fix the fail state, the app may resume communicating with the operating system to transmit the content of the upload queue by setting the upload queue to an un-paused paused state.

As illustrated in this scenario, while the device is still in a fail state, new content can be created and stored in the system. The new content may include, but is not limited to, a saved file, a photo, a screenshot, or the like. The operating system may then notify the app of the new content (525). When the app receives the notification of the new content (530), the app can then detect the new content and add the new content to the upload queue (535) and check the pause state of the upload queue (540). Since the upload queue is in the paused state, the new content is added to the upload queue, but no attempt to upload the new photo takes place.

When the device returns to a successful state, as illustrated in this scenario, the operating system may notify the app of the state change (545) and the app can receive the notification of the state change (550). As soon as the app receives the notification of the state change (550), the app can detect the status of the state change (555) by communicating with the operating system to confirm a successful state, and then un-pause the upload queue (560). Once the upload queue is in an un-paused state, the app, via an API with the operating system, may activate the network and attempt to upload the new content (565) previously added to the upload queue.

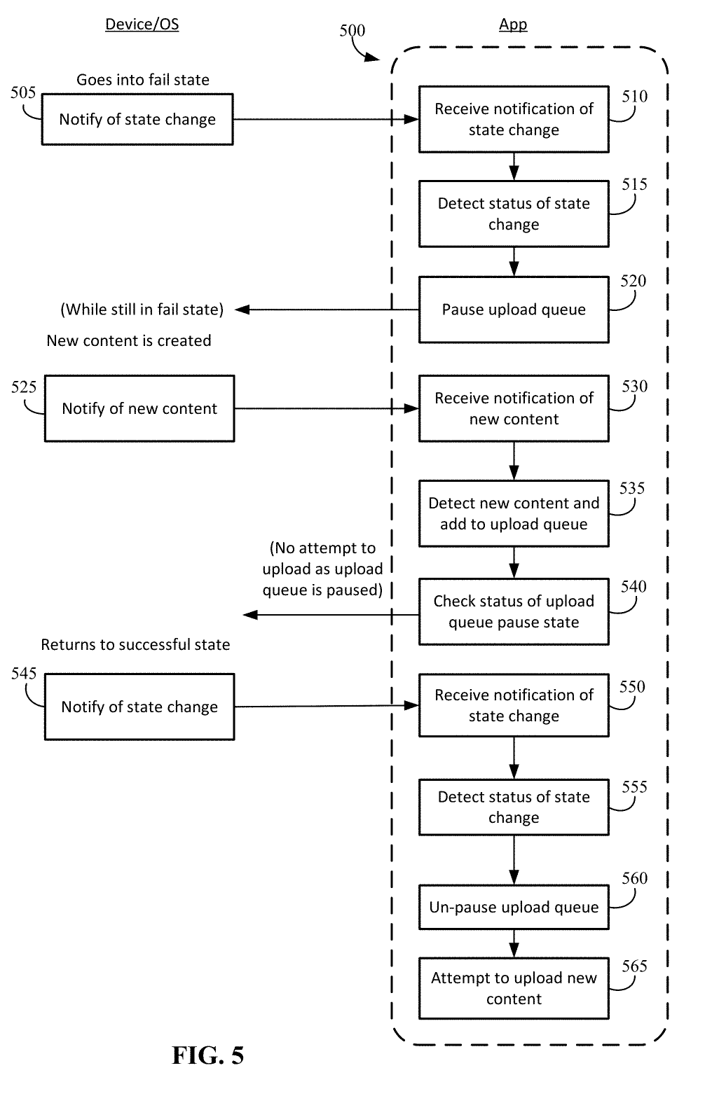

FIG. 6 illustrates an example user interface of an application that incorporates application resource usage reduction. Referring to FIG. 6, a user may interact with a computing device 600 running an app, such as app 116, as described in FIG. 1, through a user interface (UI), such as UI 602, to enter user input and receive displayed output.

A computing device (e.g., the computing device 600) is configured to receive input from a user through, for example, a keyboard, mouse, trackpad, touch pad, touch screen, microphone, camera, eye gaze tracker, or other input device. A UI enables a user to interact with various apps running on or displayed through the computing device 600. Generally, a UI is configured such that a user may easily interact with functionality of an application. For example, a user may simply select (via, for example touch, clicking, gesture, or voice) an option (e.g. a cancel command 620 or a network settings command 615) within a UI to perform an operation of the computing device 600.

As illustrated, the app (e.g., the app 116) provides the user with a UI (e.g., the UI 610) that informs the user of a fail state, such as no network connection or cloud storage full. The user can, based on the fail state, choose to fix the failure. For example, in the illustrated case of a network connection failure, the computing device 600 implementing the app may provide the UI 610 for the user. The UI 610 may display a message to the user that the upload attempt failed because of a network error, as well as how to correct the failure. For example, if the computing device 600 loses the network connection, as illustrated in FIG. 6, as a user takes photos with a camera of the computing device 600 and views the photos in a Recent Photos section 605, such as a camera roll, of UI 602 the user may be provided with the UI 610 displaying error message 625. The error message 625 may state “Error Uploading Photos: No Network Connection” and “To Continue Upload: Connect to Network”.

In some cases, along with the error message 625, the network settings command 615 may be provided to allow the user to change network settings of the computing device 600, such as connecting to Wi-Fi or changing the settings to allow the app to upload the content in the upload queue. If the user fixes the loss of network connection, the app resumes uploading the content by setting the upload queue to an un-paused state. In some cases, if the user does not want to change the network settings, the user may select the cancel command 620 and the upload queue will remain paused until the computing device 600 gains a network connection. Although the illustrated UI 602 shows the error message UI 610 blocking the app UI 602 and requiring a user interaction, the error message UI 610 may be a passive UI that is used to inform the user that upload is paused and/or that there is an error. In some implementations of a passive UI, a hyper link may be included in the passive UI to suggest a place where the user can correct the error. Of course, a hyper link may also be included in the active UIs.

FIG. 7 shows a block diagram illustrating components of a computing device that may be used in certain implementations described herein. System 700 may be implemented within a single computing device or distributed across multiple computing devices or sub-systems that cooperate in executing program instructions. System 700 can be used to implement a myriad of computing devices, including but not limited to a personal computer, a tablet computer, a reader, a mobile device, a personal digital assistant, a wearable computer, a smartphone, a laptop computer (notebook or netbook), a gaming device or console, a desktop computer, or a smart television. Accordingly, more or fewer elements described with respect to system 700 may be incorporated to implement a particular computing device.

System 700, for example, includes a processor 705 which processes data according to the instructions of one or more application programs 710 interacting with the device operating system (OS) 715. Examples of processors 705 include general purpose central processing units, application specific processors, and logic devices, as well as any other type of processing device, combinations, or variations thereof.

The application programs 710, OS 715, and other software may be loaded into and stored in a storage system 720. Device operating systems 715 generally control and coordinate the functions of the various components in the computing device, providing an easier way for applications to connect with lower level interfaces like the networking interface. Non-limiting examples of operating systems include WINDOWS from Microsoft Corp., IOS from Apple, Inc., ANDROID OS from Google, Inc., WINDOWS RT from Microsoft, and the Ubuntu variety of the Linux OS from Canonical.

It should be noted that the OS 715 may be implemented both natively on the computing device and on software virtualization layers running atop the native Device OS. Virtualized OS layers, while not depicted in FIG. 7, can be thought of as additional, nested groupings within the OS 715 space, each containing an OS, application programs, and APIs. Application programs 710 can access certain functionality of the system 700 via the APIs.

An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

An API allows a developer of an API-calling component (which may be a third party developer) to leverage specified features provided by an API-implementing component. There may be one API-calling component or there may be more than one such component. An API can be a source code interface that a computer system or program library provides to support requests for services from an application. The operating system can have multiple APIs to allow applications running on the operating system to call one or more of those APIs, and a service (such as a program library) can have multiple APIs to allow an application that uses the service to call one or more of those APIs. An API can be specified in terms of a programming language that can be interpreted or compiled when an application is built.

In some implementations, the API-implementing component may provide more than one API, each providing a different view of or with different aspects that access different aspects of the functionality implemented by the API-implementing component. For example, one API of an API-implementing component can provide a first set of functions and can be exposed to third party developers, and another API of the API-implementing component can be hidden (not exposed) and provide a subset of the first set of functions and also provide another set of functions, such as testing or debugging functions which are not in the first set of functions. In other cases, the API-implementing component may itself call one or more other components via an underlying API and thus be both an API-calling component and an API-implementing component.

An API defines the language and parameters that API-calling components use when accessing and using specified features of the API-implementing component. For example, an API-calling component accesses the specified features of the API-implementing component through one or more API calls or invocations (embodied for example by function or method calls) exposed by the API and passes data and control information using parameters via the API calls or invocations. The API-implementing component may return a value through the API in response to an API call from an API-calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API-calling component) and an API-implementing component. Transferring the API calls may include issuing, initiating, invoking, calling, receiving, returning, or responding to the function calls or messages; in other words, transferring can describe actions by either of the API-calling component or the API-implementing component. The function calls or other invocations of the API may send or receive one or more parameters through a parameter list or other structure.

Furthermore, data types or classes may be provided by the API and implemented by the API-implementing component. Thus, the API-calling component may declare variables, use pointers to, use or instantiate constant values of such types or classes by using definitions provided in the API.

Generally, an API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic. In some cases, an API may allow a client program to use the services provided by a Software Development Kit (SDK) library. In other cases, an application or other client program may use an API provided by an Application Framework. Here, the application or client program may incorporate calls to functions or methods provided by the SDK and provided by the API or use data types or objects defined in the SDK and provided by the API. An Application Framework may, for example, provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API-calling component may be a local component (i.e., on the same data processing system as the API-implementing component) or a remote component (i.e., on a different data processing system from the API-implementing component) that communicates with the API-implementing component through the API over a network (e.g., the network 155). It should be understood that an API-implementing component may also act as an API-calling component (i.e., it may make API calls to an API exposed by a different API-implementing component) and an API-calling component may also act as an API-implementing component by implementing an API that is exposed to a different API-calling component.

The API may allow multiple API-calling components written in different programming languages to communicate with the API-implementing component (thus the API may include features for translating calls and returns between the API-implementing component and the API-calling component); however the API may be implemented in terms of a specific programming language. An API-calling component can, in some cases, call APIs from different providers such as a set of APIs from an operating system provider and another set of APIs from a plug-in provider and another set of APIs from another provider (e.g. the provider of a software library) or creator of the another set of APIs.

The API, API-implementing component, and API-calling component may be stored in storage system 720.

Storage system 720 may comprise any computer readable storage media readable by the processor 705 and capable of storing software (e.g., application programs 710 and OS 715).

Storage system 720 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the storage medium a propagated signal. In addition to storage media, in some implementations storage system 720 may also include communication media over which software may be communicated internally or externally. Storage system 720 may be implemented as a single storage device but may also be implemented across multiple storage devices or sub-systems co-located or distributed relative to each other. Storage system 720 may comprise additional elements, such as a controller, capable of communicating with processor 705.

In various implementations, data/information stored via the system 700 may include data caches, such as cache 725, stored locally on the device or the data may be stored on any number of storage media that may be accessed by the device via the network/communications interface 735 or via a wired connection between the device and a separate computing device associated with the device, for example, a server computer in a distributed computing network, such as the Internet. As should be appreciated such data/information may be accessed through the device via the network/communications interface 735 or a distributed computing network. Similarly, such data/information may be readily transferred between computing devices for storage and use according to well-known data/information transfer and storage means, including electronic mail and collaborative data/information sharing systems.

Software may be implemented in program instructions and among other functions may, when executed by system 700 in general or processor 705 in particular, direct system 700 or processor 705 to operate as described herein. Software may include additional processes, programs, or components, such as operating system software or other application software. Software may also comprise firmware or some other form of machine-readable processing instructions executable by processor 705.

In general, software may, when loaded into processor 705 and executed, transform computing system 700 overall from a general-purpose computing system into a special-purpose computing system customized to facilitate the reduction of resource usage, as described herein for each implementation. Indeed, encoding software on storage system 720 may transform the physical structure of storage system 720. The specific transformation of the physical structure may depend on various factors in different implementations of this description. Examples of such factors may include, but are not limited to the technology used to implement the storage media of storage system 720 and whether the computer-storage media are characterized as primary or secondary storage.

For example, if the computer-storage media are implemented as semiconductor-based memory, software may transform the physical state of the semiconductor memory when the program is encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

It should be noted that many elements of system 700 may be included in a system-on-a-chip (SoC) device. These elements may include, but are not limited to, the processor 705, a network/communications interface 735, an audio interface 740, a video interface 745, and even elements of the storage system 720.

Network/communications interface 735 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the network/communications interface 735 are controlled by the OS 715, which informs applications and APIs of communications events when necessary.

Interface devices 750 may include input devices such as a camera 755, a mouse (not shown), track pad (not shown), keyboard (not shown), microphone (not shown), a touch device (not shown) for receiving a touch gesture from a user, a motion input device (not shown) for detecting non-touch gestures and other motions by a user, and other types of input devices and their associated processing elements capable of receiving user input.

The interface devices 750 may also include output devices such as display screens (not shown), speakers (not shown), haptic devices for tactile feedback, and other types of output devices. In certain cases, the input and output devices may be combined in a single device, such as a touchscreen display which both depicts images and receives touch gesture input from the user. Visual output may be depicted on the display in myriad ways, presenting graphical user interface elements, text, images, video, notifications, virtual buttons, virtual keyboards, or any other type of information capable of being depicted in visual form. Other kinds of user interface are possible. User interface 750 may also include associated user interface software executed by the OS 715 in support of the various user input and output devices. Such software assists the OS in communicating user interface hardware events to application programs 710 using defined mechanisms.

It should be understood the any mobile or desktop computing device implementing system 700 may have additional features or functionality and is not limited to the configurations described herein.

Certain aspects of the invention provide the following non-limiting embodiments:

### Example 1

A method of reducing resource usage by an application running on a computing device, the method comprising: managing, at the computing device, an upload queue for transmitting content received at the computing device to a cloud service; checking a state of the upload queue, including whether the upload queue is indicated to be in an un-paused state or a paused state; after checking the state of the upload queue and while the upload queue is indicated to be in the un-paused state, performing, at the computing device, an upload process by transmitting content indicated as new in the upload queue to the cloud service using a network resource of the computing device; and detecting network connection changes of a loss of network connection and an availability of the network connection, wherein in response to detecting the loss of the network connection, the upload queue is set to the paused state. The detecting the network connection occurs outside the process of uploading content in response to new content in an upload queue.

### Example 2

The method of example 1, further comprising: detecting new content; in response to detecting the new content, indicating the new content as new in the upload queue; if the upload queue is in the paused state, not communicating with an operating system to transmit the new content to the cloud service; and if the upload queue is in an un-paused state, communicating with the operating system to transmit the new content to the cloud service.

### Example 3

The method of example 1 or 2, wherein detecting network changes comprises: receiving a failure indication of a failure to transmit the content indicated as new in the upload queue to the cloud service, wherein the failure indication indicates a network connection error.

### Example 4

The method of any of examples 1-3, further comprising registering with the operating system to receive a trigger notifying of a network connection change; wherein detecting network changes comprises receiving a notification of the network connection change.

### Example 5

The method of any of examples 1-4, wherein managing the upload queue comprises: in response to detecting new content, indicating the new content as new in the upload queue; and if the new content successfully transmits to the cloud service, indicate the new content as sent in the upload queue.

### Example 6

The method of any of examples 1-5, wherein in response to detecting the availability of the network connection, the upload queue is set to the un-paused state.

### Example 7

The method of any of examples 1-6, wherein the content comprises at least one of a photograph, a screenshot, and a saved file.

### Example 8

A system comprising: a processing system; one or more computer readable storage media; and an upload queue stored on the one or more computer readable storage media; an operating system stored on the one or more computer readable storage media; an application embodied in program instructions stored on the one or more computer readable storage media that, when executed by the processing system, direct the processing system to at least: manage the upload queue for transmitting content to a cloud service; check a state of the upload queue, including whether the upload queue is indicated to be in an un-paused state or a paused state; after checking the state of the upload queue and while the upload queue is indicated to be in the un-paused state, perform an upload process by transmitting content indicated as new in the upload queue to the cloud service using a network resource of the computing device; and detect state changes of a fail state and a successful state, wherein in response to detecting the fail state, the upload queue is set to the paused state. The detecting the network connection occurs outside the process of uploading content in response to new content in an upload queue.

### Example 9

The system of example 8, wherein the program instructions stored on the one or more computer readable storage media further direct the processing system to: in response to detecting new content, indicate the new content as new in the upload queue; if the upload queue is in the paused state, not communicate with the operating system to transmit the new content to the cloud service; and if the upload queue is in an un-paused state, communicating with the operating system to transmit the new content to the cloud service.

### Example 10

The system of example 8 or 9, wherein the instructions that direct the processing system to detect the state changes of the fail state and the successful state, direct the processing system to at least: receive a failure indication of a failure to transmit the content indicated as new in the upload queue to the cloud service, wherein the failure indication indicates a known error.

### Example 11

The system of any of examples 8-10, wherein the instructions that direct the processing system to detect the state changes of the fail state and the successful state, direct the processing system to at least: register with the operating system to receive a trigger notifying of a state change; and receive a notification of the state change.

### Example 12

The system of any of examples 8-11, wherein the instructions that direct the processing system to manage the upload queue, direct the processing system to at least: in response to detecting new content, indicate the new content as new in the upload queue; and if the new content successfully transmits to the cloud service, indicate the new content as sent in the upload queue.

### Example 13

The system of any of examples 8-12, wherein in response to detecting the successful state, the upload queue is set to an un-paused state.

### Example 14

The system of any of examples 8-13, wherein the content comprises at least one of a photograph, a screenshot, and a saved file.

### Example 15

One or more computer readable storage media having an application stored thereon that when executed by a processing system, directs the processing system to perform the method comprising: managing, at the computing device, an upload queue for transmitting content received at the computing device to a cloud service; checking a state of the upload queue, including whether the upload queue is indicated to be in an un-paused state or a paused state; after checking the state of the upload queue and while the upload queue is indicated to be in the un-paused state, performing, at the computing device, an upload process by transmitting content indicated as new in the upload queue to the cloud service using a network resource of the computing device; and detecting network connection changes of a loss of network connection and an availability of the network connection, wherein in response to detecting the loss of the network connection, the upload queue is set to the paused state. The detecting the network connection occurs outside the process of uploading content in response to new content in an upload queue.

### Example 16

The media of example 15, further comprising: detecting new content; in response to detecting the new content, indicating the new content as new in the upload queue; if the upload queue is in the paused state, not communicating with an operating system to transmit the new content to the cloud service; and if the upload queue is in an un-paused state, communicating with the operating system to transmit the new content to the cloud service.

### Example 17

The media of example 15 or 16, wherein detecting network changes comprises: receiving a failure indication of a failure to transmit the content indicated as new in the upload queue to the cloud service, wherein the failure indication indicates a network connection error.

### Example 18

The media of any of examples 15-17, wherein detecting network changes comprises: registering with the operating system to receive a trigger notifying of a network connection change; and receiving notification of a network connection change.

### Example 19

The media of any of examples 15-18, wherein managing the upload queue comprises: in response to detecting new content, indicating the new content as new in the upload queue; and if the new content successfully transmits to the cloud service, indicate the new content as sent in the upload queue.

### Example 20

The media of any of examples 15-19, wherein in response to detecting the availability of the network connection, the upload queue is set to an un-paused state.

It should be understood that the examples and embodiments described herein are for illustrative purposes only and that various modifications or changes in light thereof will be suggested to persons skilled in the art and are to be included within the spirit and purview of this application.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method of reducing resource usage by an application running on a computing device, the method comprising:
managing, at the computing device, an upload queue for transmitting content received at the computing device to a cloud service;
checking a state of the upload queue, including whether the upload queue is indicated to be in an un-paused state or a paused state;
after checking the state of the upload queue and while the upload queue is indicated to be in the un-paused state, performing, at the computing device, an upload process by transmitting content indicated as new in the upload queue to the cloud service using a network resource of the computing device; and
detecting network connection changes of a loss of network connection and an availability of the network connection, wherein in response to detecting the loss of the network connection, the upload queue is set to the paused state.

2. The method of claim 1, further comprising:
detecting new content;
in response to detecting the new content, indicating the new content as new in the upload queue;
if the upload queue is in the paused state, not communicating with an operating system to transmit the new content to the cloud service; and
if the upload queue is in an un-paused state, communicating with the operating system to transmit the new content to the cloud service.

3. The method of claim 1, wherein detecting network changes comprises:
receiving a failure indication of a failure to transmit the content indicated as new in the upload queue to the cloud service, wherein the failure indication indicates a network connection error.

4. The method of claim 1, further comprising registering with the operating system to receive a trigger notifying of a network connection change;
wherein detecting network changes comprises receiving a notification of the network connection change.

5. The method of claim 1, wherein managing the upload queue comprises:
in response to detecting new content, indicating the new content as new in the upload queue; and
if the new content successfully transmits to the cloud service, indicate the new content as sent in the upload queue.

6. The method of claim 1, wherein in response to detecting the availability of the network connection, the upload queue is set to the un-paused state.

7. The method of claim 1, wherein the content comprises at least one of a photograph, a screenshot, and a saved file.

8. A system comprising:
a processing system;
one or more computer readable storage media; and
an upload queue stored on the one or more computer readable storage media;
an operating system stored on the one or more computer readable storage media;
an application embodied in program instructions stored on the one or more computer readable storage media that, when executed by the processing system, direct the processing system to at least:
manage the upload queue for transmitting content to a cloud service;
check a state of the upload queue, including whether the upload queue is indicated to be in an un-paused state or a paused state;
after checking the state of the upload queue and while the upload queue is indicated to be in the un-paused state, perform an upload process by transmitting content indicated as new in the upload queue to the cloud service using a network resource of the computing device; and
detect state changes of a fail state and a successful state, wherein in response to detecting the fail state, the upload queue is set to the paused state.

9. The system of claim 8, wherein the program instructions stored on the one or more computer readable storage media further direct the processing system to:
in response to detecting new content, indicate the new content as new in the upload queue;
if the upload queue is in the paused state, not communicate with the operating system to transmit the new content to the cloud service; and
if the upload queue is in an un-paused state, communicating with the operating system to transmit the new content to the cloud service.

10. The system of claim 8, wherein the instructions that direct the processing system to detect the state changes of the fail state and the successful state, direct the processing system to at least:
receive a failure indication of a failure to transmit the content indicated as new in the upload queue to the cloud service, wherein the failure indication indicates a known error.

11. The system of claim 8, wherein the instructions that direct the processing system to detect the state changes of the fail state and the successful state, direct the processing system to at least:
register with the operating system to receive a trigger notifying of a state change; and
receive a notification of the state change.

12. The system of claim 8, wherein the instructions that direct the processing system to manage the upload queue, direct the processing system to at least:
in response to detecting new content, indicate the new content as new in the upload queue; and
if the new content successfully transmits to the cloud service, indicate the new content as sent in the upload queue.

13. The system of claim 8, wherein in response to detecting the successful state, the upload queue is set to an un-paused state.

14. The system of claim 8, wherein the content comprises at least one of a photograph, a screenshot, and a saved file.

15. One or more computer readable storage media having an application stored thereon that when executed by a processing system, directs the processing system to perform the method comprising:
managing, at the computing device, an upload queue for transmitting content received at the computing device to a cloud service;
checking a state of the upload queue, including whether the upload queue is indicated to be in an un-paused state or a paused state;
after checking the state of the upload queue and while the upload queue is indicated to be in the un-paused state, performing, at the computing device, an upload process by transmitting content indicated as new in the upload queue to the cloud service using a network resource of the computing device; and
detecting network connection changes of a loss of network connection and an availability of the network connection, wherein in response to detecting the loss of the network connection, the upload queue is set to the paused state.

16. The media of claim 15, further comprising:
detecting new content;
in response to detecting the new content, indicating the new content as new in the upload queue;
if the upload queue is in the paused state, not communicating with an operating system to transmit the new content to the cloud service; and
if the upload queue is in an un-paused state, communicating with the operating system to transmit the new content to the cloud service.

17. The media of claim 15, wherein detecting network changes comprises:
receiving a failure indication of a failure to transmit the content indicated as new in the upload queue to the cloud service, wherein the failure indication indicates a network connection error.

18. The media of claim 15, wherein detecting network changes comprises:
registering with the operating system to receive a trigger notifying of a network connection change; and
receiving notification of a network connection change.

19. The media of claim 15, wherein managing the upload queue comprises:
in response to detecting new content, indicating the new content as new in the upload queue; and
if the new content successfully transmits to the cloud service, indicate the new content as sent in the upload queue.

20. The media of claim 15, wherein in response to detecting the availability of the network connection, the upload queue is set to an un-paused state.
